(19) United States
(12) Patent Application Publication
(10) Pub. No.: US 2012/0204110 A1
(43) Pub. Date: Aug. 9, 2012

(54) SYSTEM AND METHOD FOR AN IN-SYSTEM EMAIL INTERFACE

(75) Inventor: Cesar Cabral, Los Angles, CA (US)

(73) Assignee: HONDA MOTOR CO., LTD., Tokyo (JP)

(21) Appl. No.: 13/020,718

(22) Filed: Feb. 3, 2011

(51) Int. Cl. G06F 3/048; G06F 3/16

(52) U.S. Cl. 715/727

(57) ABSTRACT

The embodiments describe an in-vehicle text email method and system. The in-vehicle text email system provides email to a driver in a format that is suitable for output in a vehicle. The format combines audio as well as visual output mechanisms to deliver an email to the driver in a way that minimizes the level of attention needed to digest an email while operating the vehicle.

### FIELD OF THE INVENTION

The embodiments discussed herein relate generally to electronic mail (email) systems, and more particularly to in-vehicle email systems.

### BACKGROUND

Internet email has evolved into a new standard of communication. An increasing number of people use email communication on a daily basis to communicate with others. Generally, devices such as personal computers and mobile devices such as cellular phones are the traditional devices in which people use email communication. Automobile manufactures recognize that because most people use automobiles on a daily basis for transportation purposes and email communication has become a staple of communication for the general public, development of in-vehicle email systems is desired. These in-vehicle email systems allow drivers access to their email messages while operating their vehicle.

While conventional in-vehicle email systems are capable of displaying email to drivers, these conventional systems fail to account for the attention required to operate a vehicle while being presented an email message. These conventional systems merely display email messages to the driver as if the driver were viewing the email on their computer or mobile device where the majority of the user's attention is directed to viewing the email. Conventional in-vehicle email systems fail to recognize that displaying emails in a vehicle using the same output format for displaying emails on a personal computer distracts the driver when operating the vehicle.

### SUMMARY

The embodiments provide an in-vehicle email method and system to provide email within a vehicle. The driver may use the in-vehicle email system to receive emails whose presentation format has been altered for output in the vehicle. The in-vehicle email system utilizes both audio output corresponding to text in an email as well as the visual format specific for display in vehicles to provide the email in a way that minimizes the amount of distraction that the driver is subjected to when being provided the email. Additionally, the driver controls the in-vehicle email system via controls mounted on the steering wheel of the vehicle. This configuration allows the driver to keep hands on the steering wheel while operating the in-vehicle email system.

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF THE DRAWINGS

FIG. 1 illustrates an operating environment of an in-vehicle email system according to one embodiment.

FIG. 2 illustrates steering wheel input controls mounted on a steering wheel of a vehicle for controlling the in-vehicle email system according to one embodiment.

FIG. 3A illustrates a graphical flow diagram for viewing emails in the in-vehicle email system according to one embodiment.

FIG. 3B illustrates data fields of a new email according to one embodiment.

FIG. 3C illustrates a detailed view a graphical user interface of a message body of an email according to one embodiment.

FIG. 3D illustrates a graphical user interface illustrating how to traverse the message body of an email according to one embodiment.

FIG. 3E illustrates a graphical flow diagram depicting how to traverse through pages of items according to one embodiment.

FIG. 4 illustrates quick functions of the in-vehicle email system according to one embodiment.

FIG. 5 illustrates a graphical flow diagram illustrating email text-to-speech of the in-vehicle email system according to one embodiment.

FIG. 6 illustrates a method for outputting an email in a vehicle according to one embodiment.

FIG. 7 illustrates a method for converting an email into an output format suitable for output in a vehicle according to one embodiment.

FIG. 8 illustrates a method for identifying text segments in an email according to one embodiment.

FIGS. 9A through 9F illustrates an example of adding split markers to a body of text, according to one embodiment.

The figures depict various embodiments for purposes of illustration only. One skilled in the art will readily recognize from the following discussion that alternative embodiments of the structures and methods illustrated herein may be employed without departing from the principles of the embodiments described herein.

### DETAILED DESCRIPTION

Embodiments are now described with reference to the figures where like reference numbers indicate identical or functionally similar elements. Also in the figures, the left most digits of each reference number corresponds to the figure in which the reference number is first used.

Reference in the specification to “one embodiment” or to “an embodiment” means that a particular feature, structure, or characteristic described in connection with the embodiments is included in at least one embodiment. The appearances of the phrase “in one embodiment” or “an embodiment” in various places in the specification are not necessarily all referring to the same embodiment.

Some portions of the detailed description that follows are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps (instructions) leading to a desired result. The steps are those requiring physical manipulations of physical quantities. Usually, though not necessarily, these quantities take the form of electrical, magnetic or optical signals capable of being stored, transferred, combined, compared and otherwise manipulated. It is convenient at times, principally for reasons of common usage, to refer to these signals as bits, values, elements, symbols, characters, terms, numbers, or the like. Furthermore, it is also convenient at times, to refer to certain arrangements of steps requiring physical manipulations or transformation of physical quantities or representations of physical quantities as modules or code devices, without loss of generality.

However, all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or “determining” or the like, refer to the action and processes of a computer system, or similar electronic computing device (such as a specific computing machine), that manipulates and transforms data represented as physical (electronic) quantities within the computer system memories or registers or other such information storage, transmission or display devices.

Certain aspects of the embodiments described herein include process steps and instructions described herein in the form of an algorithm. It should be noted that the process steps and instructions of the embodiments could be embodied in software, firmware or hardware, and when embodied in software, could be downloaded to reside on and be operated from different platforms used by a variety of operating systems. The embodiments can also be in a computer program product which can be executed on a computing system.

The embodiments also relates to an apparatus for performing the operations herein. This apparatus may be specially constructed for the purposes, e.g., a specific computer, or it may comprise a general-purpose computer selectively activated or reconfigured by a computer program stored in the computer. Such a computer program may be stored in a non-transitory computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Memory can include any of the above and/or other devices that can store information/data/programs. Furthermore, the computers referred to in the specification may include a single processor or may be architectures employing multiple processor designs for increased computing capability.

The algorithms and displays presented herein are not inherently related to any particular computer or other apparatus. Various general-purpose systems may also be used with programs in accordance with the teachings herein, or it may prove convenient to construct more specialized apparatus to perform the method steps. The structure for a variety of these systems will appear from the description below. In addition, the embodiments are not described with reference to any particular programming language. It will be appreciated that a variety of programming languages may be used to implement the teachings of the embodiments as described herein, and any references below to specific languages are provided for disclosure of enablement and best mode of the embodiments.

In addition, the language used in the specification has been principally selected for readability and instructional purposes, and may not have been selected to delineate or circumscribe the inventive subject matter. Accordingly, the disclosure of the embodiments is intended to be illustrative, but not limiting, of the scope of the embodiments, which is set forth in the claims.

### System Overview

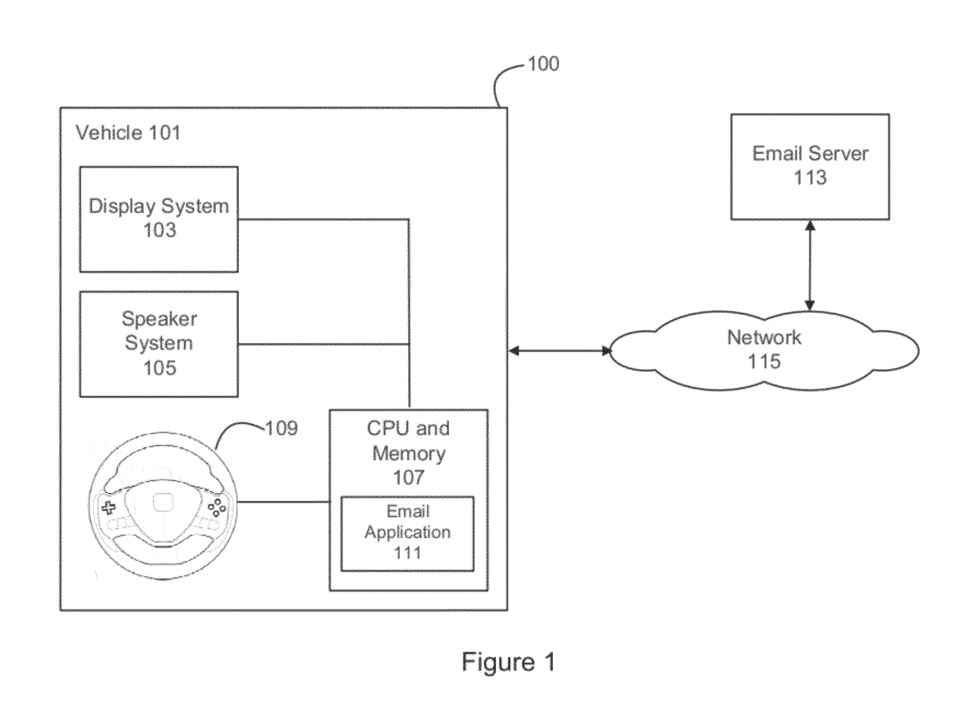

Referring now to FIG. 1, there is shown one embodiment of an in-vehicle email system 100 for providing email messages (herein referred to as an “email” or “emails”) to drivers during vehicle operation. The in-vehicle email system 100 formats received emails into an output format suitable for output in a vehicle. As described in the Background Section, the display format used when displaying emails on devices such as personal computers and mobile devices is conducive to driver distraction when used to display emails in vehicles. By converting received emails to the output format described herein, a driver's focus on emails is reduced.

In one embodiment, the output format comprises the in-vehicle system 100 providing text-to-speech audio output of the contents of emails in addition to displaying emails in a format suitable for output in a vehicle. Thus, the in-vehicle system 100 further reduces the driver distraction when providing emails to drivers by outputting audio corresponding to text in emails. In other words, the amount of driver attention that is diverted from the road to the in-vehicle email system 100 is minimized.

As shown in FIG. 1, the in-vehicle email system 100 comprises a vehicle 101. The vehicle 101 is in communication with an email server 113 via a network 115. In one embodiment, the network 115 is the Internet. However, network 115 can also be any network, including but not limited to any combination of a local area network (LAN), a metropolitan area network (MAN), a wide area network (WAN), a mobile or wireless network, a private network, or a virtual private network. The email server 113 provides emails to the vehicle 101 and receives emails sent from the vehicle 101. The email server 113 may be associated with an email service provider such as GMAIL, YAHOO! MAIL or any other email service provider. In one embodiment, the email server 113 may represent one or more server systems. For example, the email server 113 may represent a simple mail transfer protocol (SMTP) server for sending emails and a post office protocol (POP3) server for receiving emails.

In one embodiment, vehicle 101 comprises a display system 103, a speaker system 105, a computer processing unit (CPU) and memory 107 and a steering wheel 109. In other embodiments, the vehicle 101 may include components other than those illustrated in FIG. 1. Note that in the embodiments herein, the vehicle is representative of an automobile, but may also represent aircraft, watercraft, or any other types of transportation means where a user may want to be delivered emails during operation of the vehicle.

The display system 103 represents any device equipped to visually display emails as described herein as well as any graphical images or video. The display system 103 displays to a driver (i.e., a user) of vehicle 101 email interfaces used by the in-vehicle email system 100 to provide the driver with emails. The display system 103 may comprise, for example, an organic light emitting diode display (OLED), liquid crystal display (LCD), cathode ray tube (CRT) display, or any other similarly equipped display device, screen or monitor. The display system 103 may be implemented in a heads up display, navigation system display, or any display system within the vehicle 101.

The speaker system 105 represents the speaker head unit, speakers, and/or amplifiers used to output audio in the vehicle 101. The speaker system 105 outputs audio corresponding to text included in emails. By outputting audio corresponding to the text, the driver may continue viewing the road during vehicle operation rather than viewing emails on the display system 103. Thus, the driver may be provided content of emails without the driver having to view the display system 103 or may minimize the amount of time that the driver views the display system 103. In addition, the speaker system 105 outputs audio from various sources such as radio stations, compact disk, cassette, or MP3.

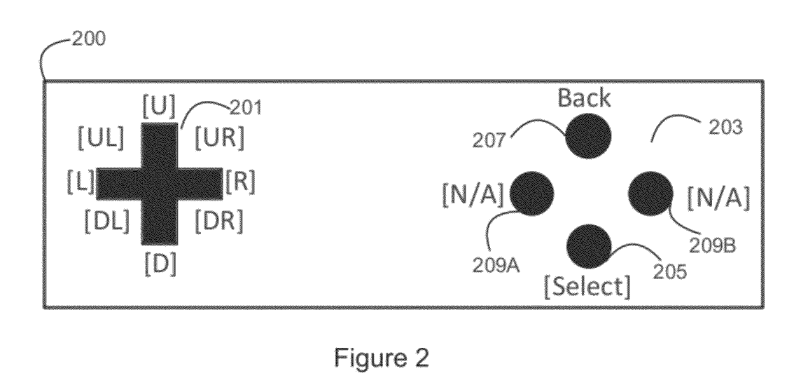

In one embodiment, the steering wheel 109 of the vehicle 101 allows the driver to control the in-vehicle email system 100 while operating vehicle 101. The steering wheel 109 comprises controls used by the driver to provide commands to an email application 111 of the in-vehicle email system 100 which will be described in further detail below. In an alternative embodiment, the controls may be positioned elsewhere such as on a center console of the vehicle for example. Referring now to FIG. 2, there is shown one embodiment of the steering wheel input controls 200 of the steering wheel 109 used for controlling an email application 111. The controls 200 comprise a directional pad 201 and buttons 203. As shown in FIG. 2, the directional pad 201 is mounted on the left side of the steering wheel 109 and the buttons are mounted on the right side of the steering wheel 109. However, in alternative embodiments the controls 200 may be placed at different locations of the steering wheel 109 other than those shown herein or may be located in other locations separate from the steering wheel such as on the center console.

The directional pad 201 is used by the driver of vehicle 101 to control the movement of a cursor of the email application 111 that is displayed on the display system 103. The cursor is used by the driver to highlight emails for selection and/or highlight email functionality for selection as will be described in further detail below. The directional pad 201 may move the cursor in the following eight directions:
up [U];
up-right [UR];
right [R];
down-right [DR];
down [D];
down-left [DL];
left [L]; and
up-left [UL].

To select the up, down, left, or right direction, the driver presses the directional pad 201 in the corresponding direction. To select the up-right direction, the driver substantially simultaneously selects the up and right directions of the directional pad 201. Similarly, to select the down-right direction, the driver substantially simultaneously selects the down and right directions of the directional pad 201. To select the down-left direction, the driver substantially simultaneously selects the down and left directions of the directional pad 201. To select the up-left direction, the driver substantially simultaneously selects the up and left directions of the directional pad 201. Note that in alternative embodiments, a directional ball or circular/elliptical shaped pad may also be used to control the cursor rather than the directional pad illustrated in FIG. 2.

In one embodiment, buttons 203 may include a select button 205 and a back button 207. The select button 205 on the steering wheel 109 is used to select an item displayed in the user interfaces described herein and/or to initiate an email functionality currently highlighted by the cursor, as will be described in further detail below. In an alternative embodiment, the select button may be integrated into the directional pad 201. For example, the select button may be activated by the driver pressing the center of the directional pad 201. The back button 207 allows the driver of the vehicle 101 to cancel the most recent email operation that was performed by the driver of the vehicle 101 such as return to a previous screen or undue a deletion of an email.

The buttons 203 may also include one or more buttons that initially lack any functionality. With respect to FIG. 2, these non-functional buttons correspond to the buttons 209 indicated as “N/A.” The driver of vehicle 101 may program the N/A buttons 209 to be associated with specific email functionality that is performed in response to selection of the button. For example, N/A button 209A may be programmed by the driver to be associated with a “delete” operation that deletes a selected email. In another example, N/A button 209B may be programmed by the driver to be associated with a “reply” operation that is performed responsive to selection of the button. Note that any functionality may be attributed to the N/A buttons 209 that are in the scope of the present embodiment described herein.

Referring back to FIG. 1, vehicle 101 further comprises CPU and memory 107. The CPU and memory 107 provide the in-vehicle email functionality as described herein as well as other vehicle related functions such as engine management. The CPU and memory 107 comprise a processor (not shown) that processes data signals. The processor may comprise various computing architectures including a complex instruction set computer (CISC) architecture, a reduced instruction set computer (RISC) architecture, or an architecture implementing a combination of instruction sets. CPU and memory 107 may comprise a single processor or multiple processors. The processor may comprise an arithmetic logic unit, a microprocessor, a general purpose computer, or some other information appliance equipped to transmit, receive and process electronic data signals from the display system 103, the speaker system 105, the steering wheel 109, and/or memory.

CPU and memory 107 may include memory (not shown) that stores instructions and/or data that may be executed by the processor. The instructions and/or data may comprise code (i.e., modules) for performing any and/or all of the techniques described herein. The memory may be any non-transitory computer-readable storage medium such as dynamic random access memory (DRAM) device, a static random access memory (SRAM) device, Flash RAM (non-volatile storage), combinations of the above, or some other memory device known in the art.

In one embodiment, the memory stores instructions for the email application 111 used in vehicle 101. The email application 111 provides a mechanism for receiving and/or sending emails in vehicle 101 according to the email functionality described herein. In one embodiment, the email application 111 receives email from email server 113. The email application 111 converts the received emails into an output format suitable for output in vehicle 101. The output format provided by the email application 111 minimizes the amount of attention needed by the driver to view emails while operating vehicle 101. Additionally, the email application includes text-to-speech functionality to create audio output corresponding to text within emails.

### In-Vehicle Email Format and Operation

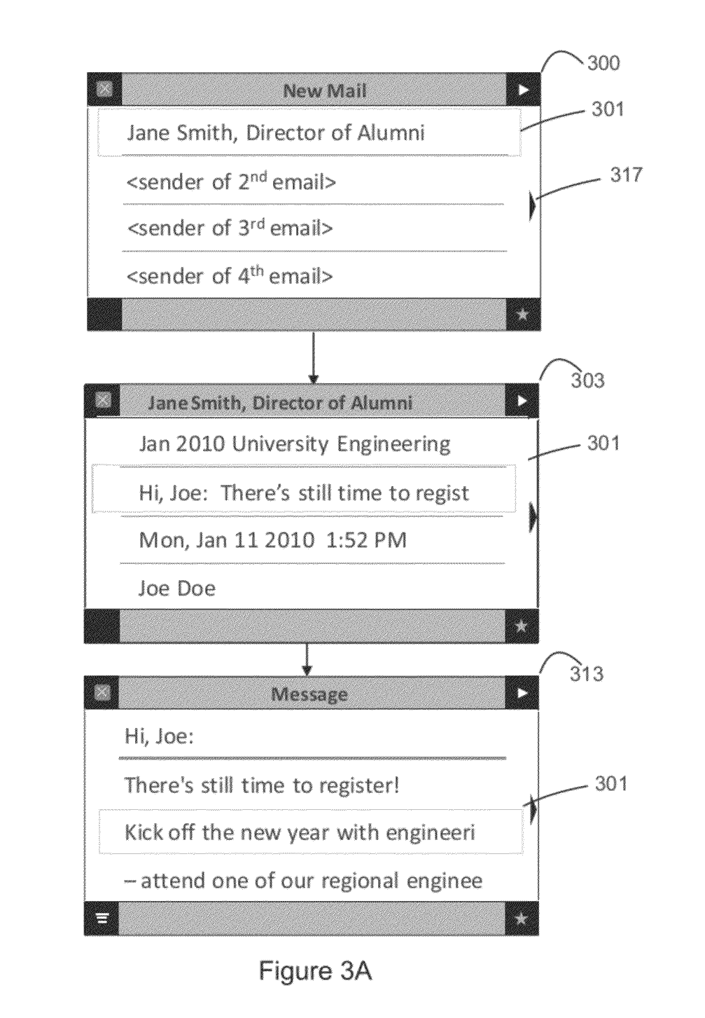

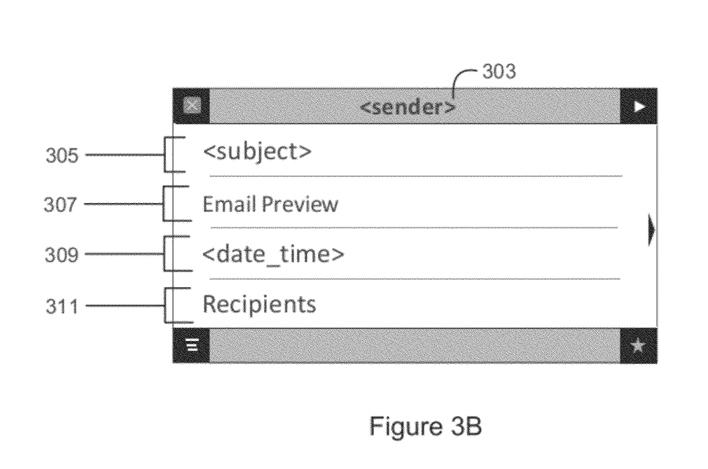

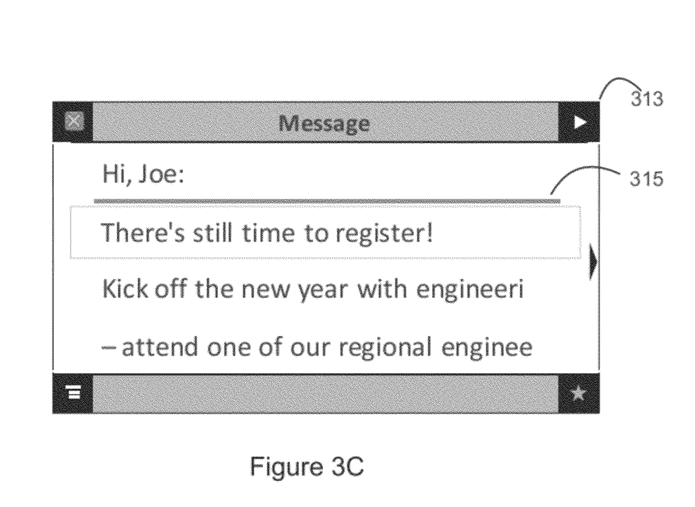

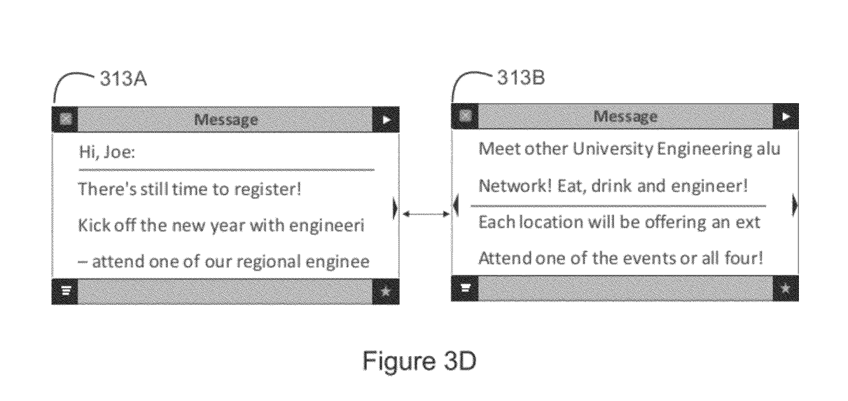

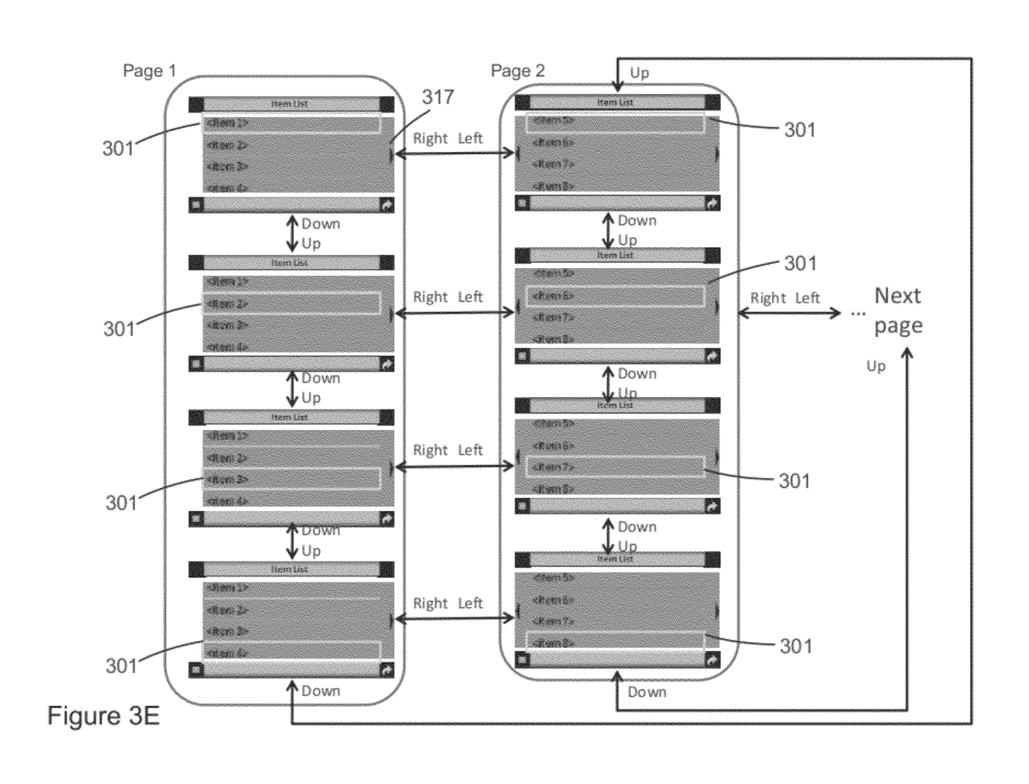

Referring now to FIG. 3, there is shown a graphical flow diagram describing how a driver accesses emails in vehicle 101 using email application 111. Upon initialization (i.e., activation) of the email application 111, a new email graphical user interface (GUI) 300 is automatically displayed to the driver of vehicle 101. Alternatively, an inbox GUI may be automatically displayed to the driver of the vehicle 101 rather than the new email GUI. In other embodiments, a home screen may be displayed upon initialization of the email application 111 that comprises various mailboxes such as an inbox, sent box, and spam box.

The new email GUI 300 displays a list of new (e.g., unread or received since a previous time) emails. The list may be ordered in chronological order or reverse chronological order according to when the emails were received. As shown in FIG. 3A, the format of the new email GUI 300 comprises a plurality of rows where each row includes an item. In the context of the new email GUI 300, each item in a row corresponds to a new email.

In the example shown in FIG. 3A, each row indicates the sender of a new email. For example, the new email GUI 300 illustrates that the first new email in the list is from “Jane Smith, Director of Alumni.” Alternatively, the list may indicate other email data fields or attributes such as the subject of the new email. In one embodiment, each row may only include a maximum number of characters. By limiting the number of characters that may be displayed in a given row, the amount of information that is delivered to the driver of the vehicle 100 is minimized thereby resulting in a less distracting interface. Alternatively, a row may scroll in a horizontal direction in order to display unviewed text within a row.

Additionally, the new email GUI 300 includes an arrow 317. An arrow 317 indicates that there are additional items to view in a given user interface. In the context of the new email GUI 300, the arrow 317 indicates there are additional new emails to view other than those that are currently displayed in the new GUI 300. Note that the other GUIs described herein also may comprise an arrow(s) on the GUIs indicating there are additional items for display.

As shown in FIG. 3A, new email GUI 300 comprises a cursor 301. The cursor 301 is controlled by the driver using the controls 200 of the steering wheel 109. The in-vehicle email system 100 receives driver input via the controls 200 on steering wheel 109 to move the position of the cursor to highlight items on a GUI. When pressing and holding the directional pad 201, the cursor 301 moves in the direction selected on the directional pad 201. Selection of a specific direction does not occur until the directional pad 201 is completely released according to one embodiment. Additionally, selection of an item may require the driver selection of the select button 205 on the steering wheel 109.

In one embodiment, highlighting an item causes the in-vehicle email system 100 to output an audio cue corresponding to the item. In the new email GUI 301, highlighting an item with cursor 301 causes the in-vehicle email system 100 to output audio corresponding to the sender of the email. By providing the audio cue, the driver of vehicle 101 may continue viewing the road rather than looking at the display system 103 to view new emails. In the example shown in FIG. 3A, the in-vehicle email system 100 outputs audio corresponding to “Jane Smith, Director of Alumni.”

Upon receiving a selection of a new email in the new email GUI 300, the in-vehicle email system 100 displays an email details GUI 303. The email details GUI 303 summarizes email attributes associated with the selected email. Similar to the format of new email GUI 300, the format of the email details GUI 303 also comprises a plurality of rows where each row includes an item specific to the context of the GUI. In the email details GUI 303, each item is associated with a data field or email attribute that describes information associated with the email.

Each row of the new email GUI 300 may also include only a threshold (i.e., maximum) number of characters in order to minimize the amount of information that is provided to the driver. According to one embodiment, if the content of a row in the new email GUI 300 exceeds the threshold, the row may scroll in the horizontal direction in order for the driver to view the content of the row. Alternatively, the driver may select the row to view/hear the entire content of the row.

In one embodiment, the cursor 301 defaults to the first row included in the email details GUI 301 which causes the in-vehicle email system 100 to output an audio cue corresponding to the item in the first row. In this example, the cursor 301 defaults to the first row of the new email GUI 300 corresponding to the subject of the email “January 2010 University Engineering.” Accordingly, the in-vehicle email system 100 automatically outputs an audio cue corresponding to “January 2010 University Engineering.” Alternatively, other defaults may be used. For example, the cursor 301 may be placed on the last email highlighted during a previous email session.

Referring now to FIG. 3B, the format of the email details GUI 303 is shown. In one embodiment, each of the plurality of rows of email details GUI 303 comprises one of the following items: a sender data field 303, subject data field 305, email preview data field 307, timestamp data field 309, and a recipient data field 311. Highlighting any of these data fields using the cursor 301 results in the in-vehicle email system 100 to output an audio cue corresponding to the text in the data field. Note that other data fields other than those illustrated in FIG. 3B may be used and that different arrangements of the data field may also be used in alternative embodiments.

The sender data field 303 indicates the sender of the email and is located in the title bar of the email details GUI 303. The sender data field may indicate the name of the sender or an email address of the sender of the email. In the example illustrated in FIG. 3A, the sender of the selected email is represented by the sender's name “Jane Smith, Director of Alumni.” The subject data field 305 indicates the subject of the email. The subject data field 305 is located in the first row of the email details GUI 303. In the example illustrated in FIG. 3A, the subject of the selected email is “January 2010 University Engineering.”

The email preview data field 307 indicates a preview of the message body of an email and is located in the second row of the email details GUI 303. Generally, the email preview data field 307 includes the first sentence of the message body. However, if the first sentence is less than a threshold number of characters (e.g., less than 15 characters), the email preview data field 307 may include the second sentence of the message body or a portion thereof. In the example illustrated in FIG. 3A, the email preview data field comprises “Hi, Joe: There's still time to regist”. Because each row of the email details GUI 303 may only display up to a threshold number of characters, the entire second sentence of the message body is not shown. The email preview data field 307 is a selectable data field. That is, responsive to selection of the email preview data field 307 using controls 200, the in-vehicle email system 100 displays a GUI including the message body of the email as will be described in further detail below.

The timestamp data field 309 includes the date and time that the email was sent by the sender of the email and is located in the third row of the email details GUI 303. The timestamp data field 309 may also indicate the day of the week that the email was sent. In the example shown in FIG. 3A, the timestamp data field indicates that the email was sent “Mon, Jan. 11, 2010 1:52 PM.”

The recipient data field 311 includes the recipients of the email message and is located in the fourth row of the email details GUI 301. The recipient data field 311 indicates one or more people who received the email message from the sender. The recipient data field 311 may indicate an email address associated with the recipient or a name of the recipient. In the example shown in FIG. 3A, the recipient data field indicates that only “Joe Doe” is a recipient of the email.

Referring back to FIG. 3A, selection of the email preview data field in email details GUI 303 (i.e., the second row) results in the display of a message body GUI 313. The message body GUI 313 comprises content of the email formatted for display in the in-vehicle email system 100. Referring now to FIG. 3C, there is shown the format of the message body used in the in-vehicle email system 100. The message body is formatted such that the content of the message body is displayed within a plurality of rows of the message body GUI 313. Each item in a row of the message body GUI 313 is associated with a sentence from the message body of the email. Thus, each descending row of the message body GUI 313 displays a sentence from the body of the message in chronological order. Additionally, message body GUI 313 displays one or more separators 315. A separator 315 is a visual indication of a new paragraph in the message body of the email.

In one embodiment, each row in the message body GUI 313 also displays up to a threshold number of characters (e.g., 40 characters). Thus, each row may include an incomplete sentence if the length of the sentence is greater than the threshold number of characters allowed in each row. In one embodiment, the driver may select the row with the incomplete sentence causing the in-vehicle email system to display the entire sentence. The in-vehicle email system may instead horizontally scroll the text within the row to display the incomplete sentence.

According to one embodiment, highlighting each row in the message body GUI 313 using cursor 301 causes the in-vehicle email system 100 to output an audio cue corresponding to the text in the row. Thus, even though an incomplete sentence may be displayed in a row, the system outputs the complete sentence. For example, rather than outputting audio associated with the text “Kick off the new year with engineeri” the system outputs audio associated with the complete sentence of “Kick off the new year with engineering friends!”

Because the message body GUI 313 may only display up to four sentences in this example, the driver may page through the message body GUI 313 to view the entire message. Referring now to FIG. 3D, there is shown the next four sentences of the message body in message body GUI 313B. In one embodiment, the driver may use the right direction on the directional pad 201 when viewing message body GUI 313A to view the next four sentences of the message body as shown in message body GUI 313B. Thus, the driver may use the left or right directions on the direction pad 201 to view pages of sentences from the message body. Alternatively, the driver may use the up and down directions on the directional pad 201 to page through the lists of sentences as will be described in FIG. 3E.

FIG. 3E illustrates a graphical flow diagram illustrating traversal of items on a GUI. The traversal is applicable to message body GUI 313 as well as the other GUIs discussed previously. Generally, to traverse items on a GUI, the driver may use the left and right buttons on the directional pad 201 or the up and down buttons on the direction pad 201.

By default, the cursor 301 highlights the first item of the first page of a GUI. Arrow 317 indicates that there is an additional page that includes more items. In one embodiment, the driver may use the down arrow to traverse through each item in the first page. That is, the driver may press the down arrow in one or most instances to move the cursor 301 to each item on the first page. The driver may also use the back button 207 of the controls 200 to return to the previous item on the page. If the cursor is positioned on the last item on the first page (e.g., item 4), further selection of the down arrow causes the second page of items to be displayed. Initiation of the back button 207 causes the display of the first page of items.

Alternatively, the driver may use right direction on the directional pad 201 to display the second page. By using the right direction to display the second page, the driver does not need to move the cursor 301 through each item in the first page to view items on the second page as described above. Rather, pressing the right direction causes the second page to be displayed to the driver. The position of the cursor 301 on the second page corresponds to the previous position of the cursor 301 prior to pressing the right direction button while on the first page. For example, if the cursor 301 is positioned on the first item (e.g., item 1) of the first page, the cursor is also positioned on the first item of the second page (e.g., item 5) in response to the selection of the right arrow button. The driver may then return to the previous page using either the left direction button or may use the up arrow to return back to the first page.

### Email Quick Functions

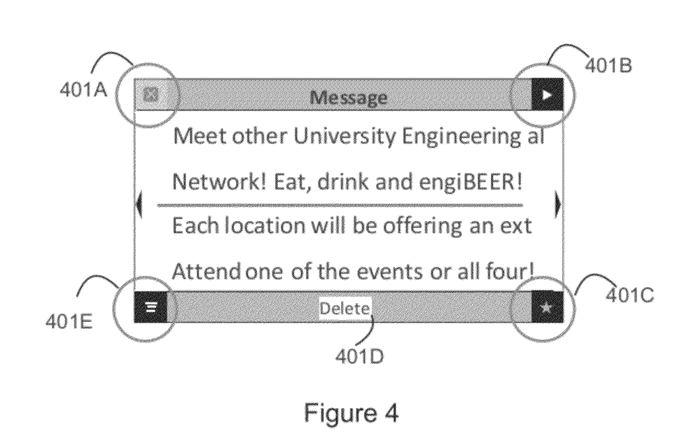

Referring now to FIG. 4, the quick functions 401 of a message body GUI are shown. Note that each of the different GUIs described herein are also associated with the quick functions 401 described herein. In one embodiment, each quick function 401 is associated with a corresponding action. To activate a quick function, the driver uses diagonal presses of the directional pad 201 in combination with the select button 205 which are received by the in-vehicle email system 100 to invoke the action. A resulting action may be undone by the driver by pressing the back button 207 on the steering wheel 109. In one embodiment, highlighting a quick function 401 with the cursor 301 causes the in-vehicle email system 100 to display a summary of the action that is associated with the quick function 401.

Close control 401A causes the in-vehicle email system 100 to close the current GUI being viewed by the driver. The in-vehicle email system 100 then provides the previous GUI that was displayed prior to the display of the closed GUI. Alternatively, the new email GUI 300 is displayed.

Play control 401B causes the in-vehicle email system 100 to output audio corresponding to the text in the displayed GUI. For example, selection of the play control 401B results in the in-vehicle email system 100 outputting the audio corresponding to the entire text in the message of the email if the play control 401B is activated in the message body GUI 313. Save control 401C causes the in-vehicle email system 100 to save an email in response to the selection of the control. Alternatively, save control 401C may be a favorites quick function that allows the driver to add the email to a favorites folder.

The delete control 401D causes the in-vehicle email system 100 to delete the current email from the system. Additionally, the in-vehicle email system 100 returns to the new email GUI 300 which is updated to reflect the deletion of the email. In one embodiment, the cursor 301 will highlight the email preceding the deleted email if available or may default to the first email in the new email GUI 300 in response to the initiation of the delete control 401D. Lastly, quick function 401E is user configurable. The driver may associate a function with the quick function 401E. For example, a reply function or mark as unread function may be associated with quick function 401E.

### Text-to-Speech

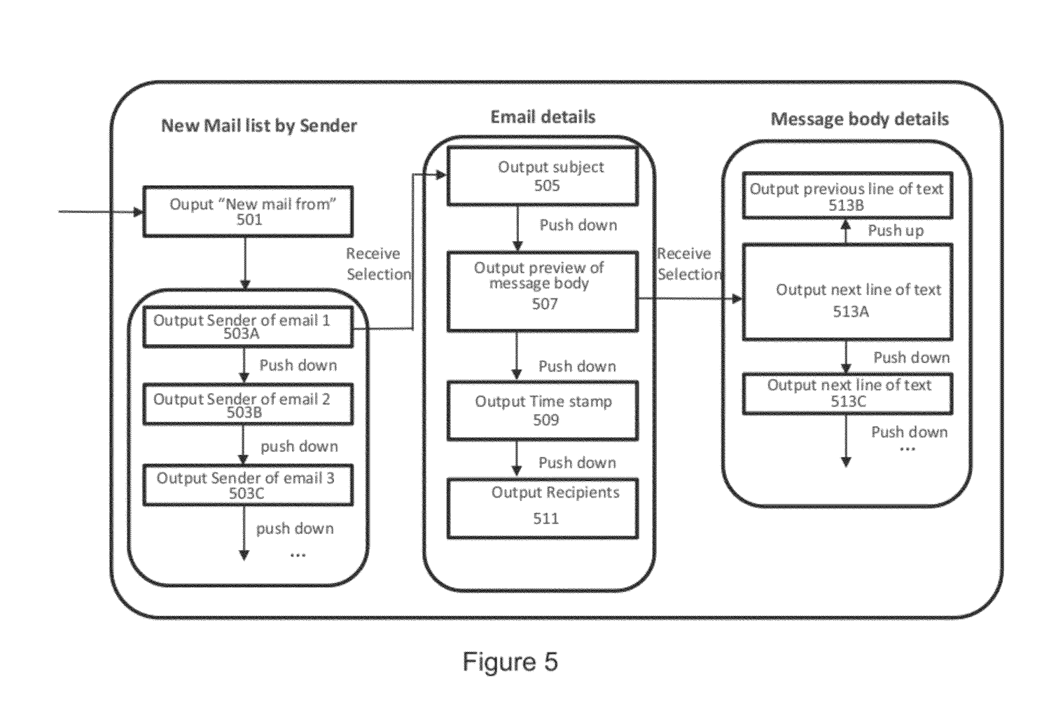

Referring now to FIG. 5, a graphical flow diagram summarizing the text-to-speech method flow of the in-vehicle email system 100 is shown. Note that in one embodiment, the in-vehicle email system 100 waits for a threshold amount of time (e.g., 0.5 second) before outputting audio corresponding to an item highlighted by the cursor 301. This prevents audio from being outputted when the driver is merely scrolling through items on a GUI.

As described previously, upon initiation of the email application 111 the new email GUI 300 is displayed that includes a list of new emails. Upon the display of the new email GUI 300, the in-vehicle email system 100 outputs 501 the audio of “New mail from” and automatically outputs audio corresponding to the sender of the first email in the list. As the driver traverses the emails in the new email GUI 300 using the down direction (or up direction) of the directional pad 201, the in-vehicle email system 100 outputs the sender associated with the email highlighted by the cursor 301.

Upon selection of an email in the new email GUI 300, the in-vehicle email system 100 displays the email details GUI 303 and automatically outputs 505 audio corresponding to the subject of the selected email. As described above, the data fields in the email details GUI 303 are respectively ordered according to subject data field, email preview data field, date/time data field, and recipient data field 311. Thus, in response to the driver moving the cursor 301 to the email preview data field via the down direction of the directional pad 201, the in-vehicle email system 100 outputs 507 audio corresponding to a preview of the message body. Similarly, the in-vehicle email system 100 outputs 509 audio corresponding to the time stamp of the email or outputs 511 audio corresponding to the recipients of the email in response to the cursor highlighting the associated data field.

In response to the driver selecting the email preview data field from the email details GUI 303, the in-vehicle email system 100 displays the message body GUI 313. The in-vehicle email system 100 then outputs 513A audio corresponding to the line of text in the email after the text associated with the email preview data field. The driver may press the up direction on the directional pad 201 to output 513B text corresponding to the preceding line of text or may press the down button to output 513C the next line of text in the body of the email.

### Email Outputting Method

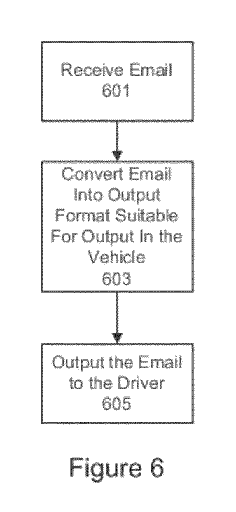

Referring now to FIG. 6, there is shown one embodiment of a method for outputting an email for output in a vehicle. Note that in other embodiments, other steps may be performed than those illustrated in FIG. 6.

In one embodiment, the in-vehicle email system 100 receives 601 an email. That is, the in-vehicle email system 100 receives from the email server 113 a new email addressed to the driver of the vehicle 101. The in-vehicle email system 100 converts 603 the received email into an output format suitable for output in the vehicle 101. For example, the in-vehicle email system 100 converts the email from a first format used for display in traditional devices used for email communication such as personal computers or mobile devices into a second format used for output in the vehicle 101. The in-vehicle email system 100 then outputs 605 the formatted email to the driver. The in-vehicle email system 100 may display the formatted email on the display system 103 and output audio corresponding to the content of the email.

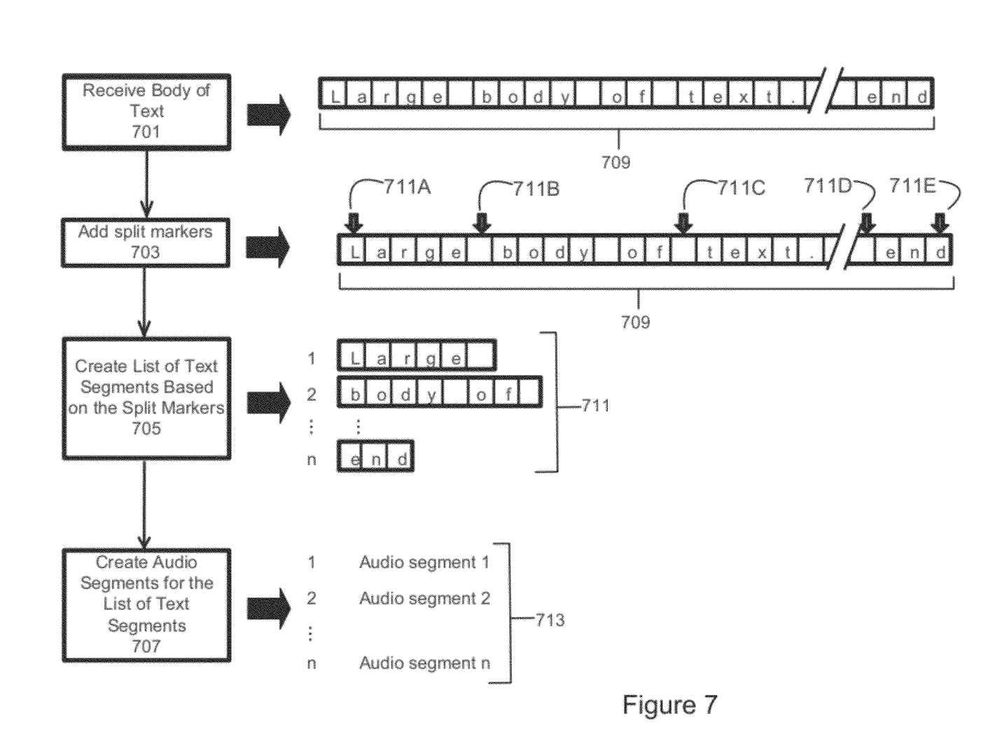

Referring now to FIG. 7, there is shown one embodiment of a method for converting the received email into an output format suitable for output in the vehicle 101 as described in FIG. 6. When a driver access email in the vehicle 101, it is not desirable to simply display the entire text of the email to the driver due to distraction issues. Rather, the in-vehicle email system 100 converts a body of text into an audible format that can be more easily consumed by the driver as will be described below. Note that in other embodiments, other steps may be performed than those illustrated in FIG. 7.

The in-vehicle email system 100 receives 701 the body of text included in the email. Text 709 is representative of a message body of an email. The in-vehicle email system 100 adds 703 split markers to the message body. The split markers indicate the starting point and ending point of a sentence or clause in the message body. The split markers may also indicate a logical point in which to split the text such that the text defined by the split markers still makes grammatical sense. For example, split markers 711 may indicate starting and ending locations of sentences in text 709. The split markers allow the in-vehicle email system 100 to create audio files that are logically self-contained yet short enough that the audio files do not overwhelm the driver with too much information.

Based on the location of the split markers in the body of text, the in-vehicle email system 100 creates 705 a list of text segments. The list of text segments comprises one or more text segments representative of sentences in the body of text. For example, the list of text segments 711 includes 1 through n text segments from the body of text 709. The text segments in the list are ordered according to the order in which the text segments appear in the body of text. The in-vehicle email system 100 creates 707 audio segments for the list of text segments thereby creating a playlist that is associated with the email. The playlist comprises a group of related audio files (e.g., MPS or WAV file) or audio segments arranged in a specific order that corresponds to the order in which each audio segment's corresponding text segment appears in the email. The playlist of audio segments is accessed by the in-vehicle email system 100 to output audio associated with a displayed email. To create the playlist, the in-vehicle email system uses text to speech technology such as IBM's VIAVOICE text-to-speech application, for example, although other text-to-speech technologies may be used in other embodiments. The list of audio segments 713 represents an example of an audio playlist for a received email.

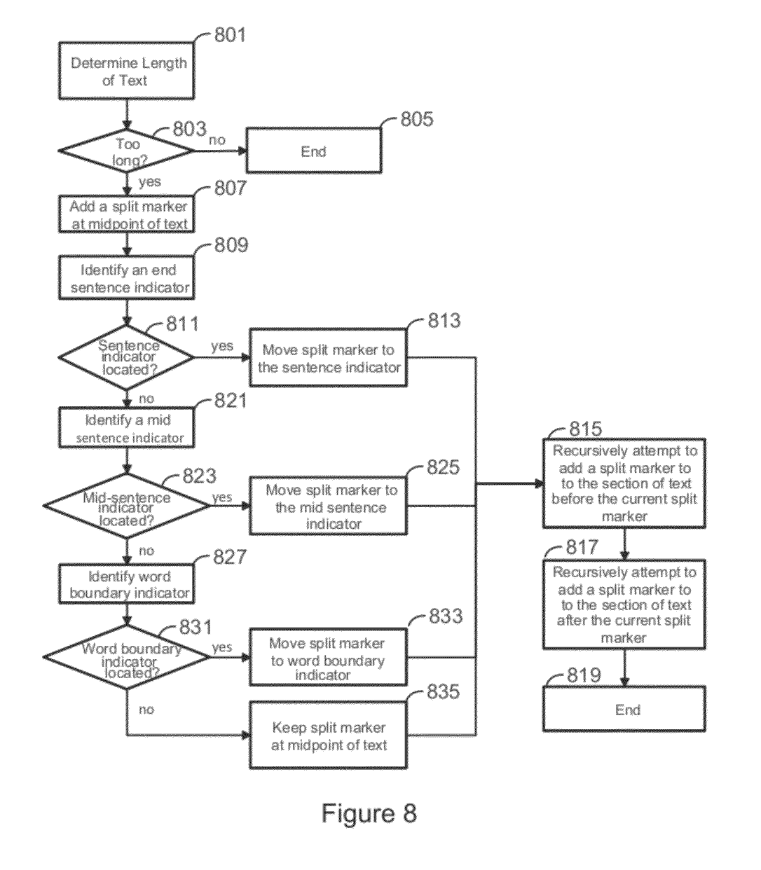

Referring now to FIG. 8, there is shown one embodiment of a method for adding split markers to a body of text as described in FIG. 7. Note that in other embodiments, other steps may be performed than those illustrated in FIG. 8.

The in-vehicle email system 100 determines 801 the length of the body of text in an email. The length is determined by counting the number of characters included in the body of text. The in-vehicle email system 100 determines 803 whether the text is too long. That is, the in-vehicle email system 100 determines whether the number of characters in the body is greater than a threshold number of characters. In one embodiment, the threshold number of characters is representative of the average English sentence length which is 73 characters. Responsive to the in-vehicle email system 100 determining that the length of the text is below the threshold number of characters, the method ends 805. Because the text does not exceed the threshold, the in-vehicle email system 100 does not add split markers to the body of text.

If the in-vehicle email system 100 determines that the length of the body of text is greater than the threshold, the system adds 807 a split marker at the midpoint of the text. To add the split marker, the system determines which character in the body of text is associated with the midpoint of the text based on the determined length of the body of text. For example, if the body of text is 100 characters long, the system adds the split marker at the character located at the 50^{th} character position. In alternative embodiments, the in-vehicle email system 100 may add the split marker to any position within the text other than the midpoint as an initial starting position for the marker.

The in-vehicle email system 100 attempts to improve the position of the split marker. To improve the position, the system attempts to identify 809 an end sentence indicator that is nearest to the midpoint of the body of text. An end sentence indicator is an indication of the end of a sentence such as certain types of punctuation. The in-vehicle email system 100 searches the body of text preceding the current position of the split marker for an end sentence indicator as well as the body of text before the current position of the split marker for an end sentence indicator. In one embodiment, the following characters are representative of an end sentence indicator:
a period (.);
a question mark (?);
an exclamation point (!);
a colon (:);
a semicolon (;);
2 spaces followed by a capital letter;
3 or more spaces;
1 ore more carriage returns or new lines; and
a tab.

The in-vehicle email system 100 determines 811 whether one of the end sentence indicators described above is located in the body of text. If system 100 identified an end sentence indicator, the system moves 813 (i.e., adjusts) the split marker to the location of the end sentence indicator. However, if the in-vehicle email system 100 was unable to identify an end sentence indicator, the system attempts to identify 821 a mid-sentence indicator in order to improve the current position of the split marker. In one embodiment, a mid-sentence indicator is representative of a word that connects two phrases or clauses together (i.e., a conjunction). The following are examples of mid-sentences indicators:
and;
but;
or;
yet;
for;
nor; and
so.

The in-vehicle email system 100 determines 823 whether one of the mid-sentence indicators described above is located in the body of text. If the system 100 identified a mid-sentence indicator, the system moves 825 the split marker to the location of the mid-sentence indicator. However, if the in-vehicle email system 100 was unable to identify a mid-sentence indicator, the system attempts to identify 827 a word boundary indicator in order to improve the current position (i.e., midpoint of text) of the split marker. In one embodiment, a word boundary indicator indicates the end of a word. Examples of a word boundary indicator comprise a comma or a single space after a word.

The in-vehicle email system 100 determines 831 whether a word boundary indicator is located in the body of text. If the system 100 identified a word boundary indicator, the system moves 833 the split marker to the word boundary indicator. However, if the in-vehicle email system 100 is unable to identify a word boundary indicator, the system keeps 835 the split market at the midpoint of the body of text in an embodiment. That is, the split market remains at its current position at the midpoint of the body of text.

Whether the split marker was moved to a sentence indicator, a mid-sentence indicator, a word boundary indicator, or kept at the midpoint of the text, the in-vehicle email system 100 recursively 815 attempts to add a split marker to the portion (i.e., section) of text preceding the current split marker. That is, the in-vehicle email system 100 repeats the method described in FIG. 8 for the portion of text before the split marker. Similarly, the in-vehicle email system 100 recursively 817 attempts to add a split marker to the section of text following the current split marker. Once the split markers have been added to the body of text, the process of adding split markers to the body of text of an email ends 819. As described in FIG. 7, the in-vehicle email system 100 then creates a list of text segments based on the split markers and creates an audio playlist for the list of text segments.

In an alternative embodiment for adding split markers to a body of text, the in-vehicle email system 100 may not initially apply a threshold to the body of text of an email when determining whether to add split markers. Rather, the in-vehicle email system 100 may automatically add one or more split markers to the body of text according to the steps described in FIG. 8. By not applying the threshold, the in-vehicle email system 100 identifies each sentence or clause within the body of text regardless of the length of the text.

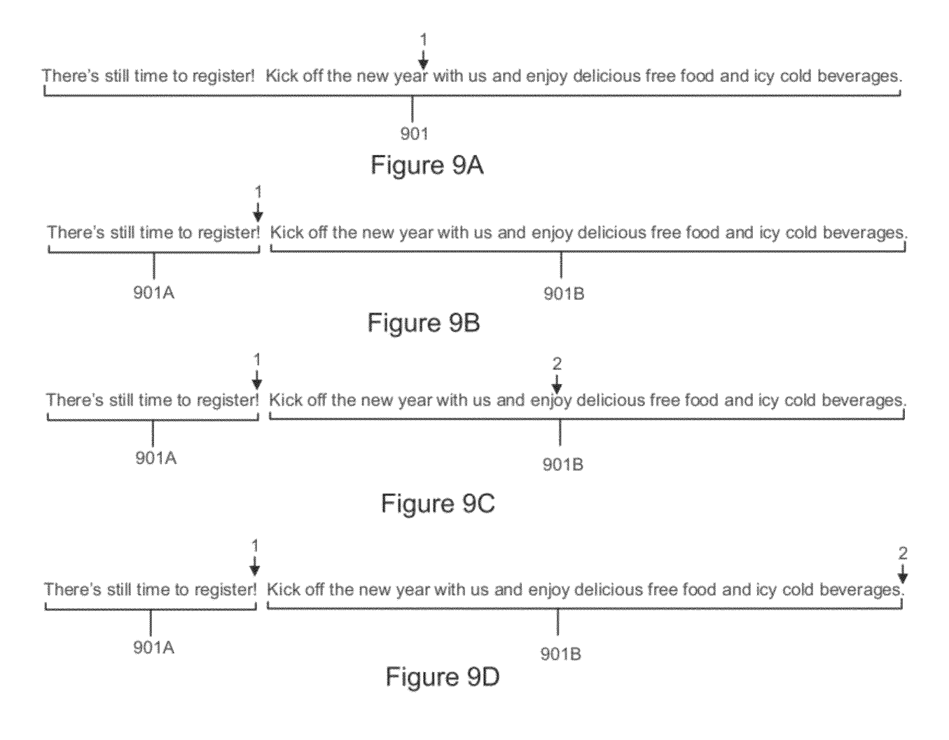

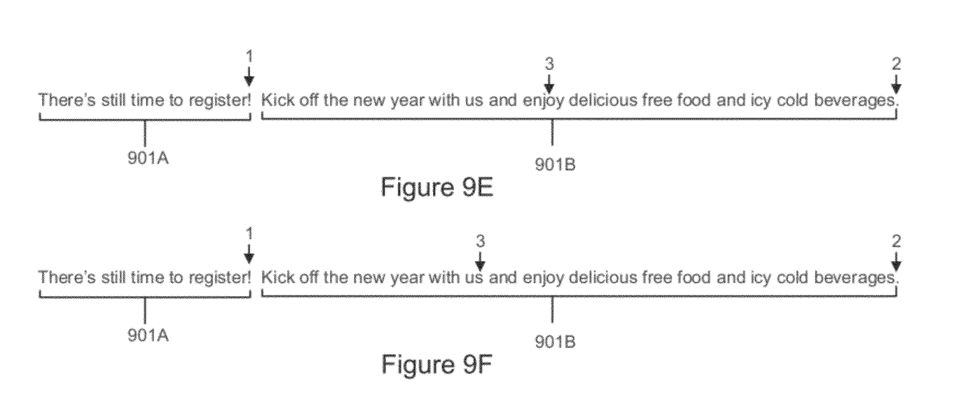

Referring now to FIGS. 9A through 9E, there is shown one example of adding split markers to a body of text in an email according to the method illustrated in FIG. 8. With respect to FIG. 9A, the in-vehicle email system 100 receives the body of text 901 and determines that the text is 124 characters in length including character spaces. The system compares the length of the body text to a threshold to determine whether the number of characters in the body of text exceeds the threshold. Assuming that the threshold is set to 73 characters, the system attempts to add a split marker at the midpoint of the text 901. Accordingly, the in-vehicle email system 100 adds the first split marker at the “r” in the word “year” since the “r” character corresponds to the midpoint of the body of text 901.

Referring now to FIG. 9B, the in-vehicle email system 100 attempts to improve the location of the first split marker by trying to move the split marker to the nearest sentence split. The system 100 determines that there are two sentence splits in the body of text 901—the exclamation point (!) and the period (.) at the end of the body of text 901. Because the exclamation point is closer to the current position of the first split marker compared to the position of the period, the in-vehicle email system 100 moves the first split marker to the location in the body of text 901 associated with the exclamation point. The system then attempts to recursively add a second split marker to the portion of text 901A preceding the first split marker. However, the portion of text 901A only comprises 31 characters which is less than the threshold number of characters. Because the number of characters in the portion of text 901A is less than the threshold, the system stops attempting to improve the position of the first split marker. But, the in-vehicle email system 100 still attempts to recursively add a second split marker to the portion of text 901B proceeding the first split marker.

Referring now to FIG. 9C, the in-vehicle email system 100 determines that the portion of text 901B is 92 characters in length and thus exceeds the threshold number of characters needed to add a split marker to the text 901B. The in-vehicle email system 100 adds the second split marker to the character “o” in the word “enjoy” which corresponds to the midpoint of text portion 901B.

Referring now to FIG. 9D, the in-vehicle email system 100 attempts to improve the location of the second split marker by attempting to move the second split marker to the nearest sentence split. The system determines that there is a single sentence splits in the body of text 901B—the period (.) at the end of the body of text 901B. Accordingly, the system places the second split marker at the location of the period in text 901B.

Referring now to FIG. 9E, the system then attempts to recursively add a third split marker to the portion of text 901B before the second split marker but after the first split marker. The system places the third split marker at the midpoint of text 901B which corresponds to the “o” in the word “enjoy” as previously described above.

Referring now to FIG. 9F, the system attempts to improve the position of the third split marker by attempting to move the third split marker to the nearest sentence split. However, the first split marker and second split marker are already located at the nearest sentence splits. The in-vehicle email system 100 thus searches the text 901B for the nearest mid-sentence split which is identified as the word “and” between words “us” and “enjoy.” In one embodiment, the in-vehicle email system 100 places the third split marker at the end of the word preceding the identified mid-sentence split which in this example is the word “us.” The in-vehicle email system 100 attempts to recursively add split markers to the portions of text before and after the third split marker, but the system determines that the length of these portions is less than the threshold. Accordingly, the system 100 stops attempting to add split markers to the text 901.

Based on the location of the split markers, the in-vehicle email system 100 creates the following text segments: 1) “There's still time to register!” 2) “Kick off the new year with us” and 3) “and enjoy delicious free food and icy cold beverages.” Using text to speech technology, the system creates an audio segment for each text segment thereby creating a playlist of audio segments for the text 901.

### Transition Sounds

In one embodiment, the in-vehicle email system 100 outputs transition sounds to indicate actions initiated in one of the GUIs described above. In one embodiment, each action is associated with a specific transition sound. For example, the in-vehicle email system 100 may output a clicking sound in response to the cursor 301 being moved from a first item to a second item. In contrast, the in-vehicle email system 100 may output a swooshing when displaying a new page of a GUI or in response to the display of a new GUI (e.g., displaying the new email GUI 300 then displaying the email details GUI 303). When an item is deleted, the in-vehicle email system 100 may output a sound corresponding to crumpling of paper whereas the in-vehicle email system 100 outputs a horn sound in response to driver selection of an item. The in-vehicle email system 100 may output other sounds in alternative embodiments.

While particular embodiments and applications of the embodiments have been illustrated and described herein, it is to be understood that the embodiments are not limited to the precise construction and components disclosed herein and that various modifications, changes, and variations may be made in the arrangement, operation, and details of the methods and apparatuses of the embodiments of the present disclosure without departing from the spirit and scope of the disclosure as it is defined in the appended claims.

What is claimed is:

1. A computer-implemented method for providing an email in a vehicle, the method comprising:
receiving an email comprising text;
receiving, via input controls, input from the driver of the vehicle to output the email;
displaying a first user interface comprising a plurality of selectable rows, each row configured to display up to a threshold number of characters;
for each sentence of a plurality of sentences in the text of the email, displaying characters of the sentence in one of the plurality of selectable rows up to the threshold number of characters;
receiving, via the input controls, input from the driver selecting one of the plurality of selectable rows; and
outputting audio corresponding to the sentence in the selected row responsive to receiving the selection.

2. The computer-implemented method of claim 1, further comprising:
converting the email from a first output format to a second output format suitable for output in the vehicle.

3. The computer-implemented method of claim 2, wherein converting the email comprises:
adding one or more markers to the text of the email, the markers identifying one or more clauses or sentences in the text;
creating a list of text segments based on the markers; and
creating a playlist of audio segments based on the list of text segments, each audio segment in the playlist corresponding to a text segment from the list of text segments.

4. The computer-implemented method of claim 3, wherein displaying, characters of the sentence in one of the plurality of selectable rows comprises:
for each text segment in the list of text segments, displaying characters of the text segment in a selectable row up to the threshold number of characters; and
wherein the text segments are displayed in the plurality of selectable rows according to an ordering of the text segments in the list of text segments.

5. The computer-implemented method of claim 3, wherein adding one or more markers to the text comprises:
identifying a length of the text based on a number of characters included in the text;
adding a marker to the text at a position corresponding to a midpoint of the text responsive to the length exceeding a threshold; and
attempting to adjust the position of the marker to either a punctuation indicative of an end of a sentence or clause in the text or to a conjunction in the text.

6. The computer-implemented method of claim 1, wherein the input controls comprise steering wheel input controls, the steering wheel input controls including a directional pad for controlling a cursor displayed on the first user interface and a selection button for selecting one of the plurality of selectable rows in the first user interface.

7. The computer-implemented method of claim 6, wherein receiving input from the driver selecting one of the plurality of selectable rows comprises:
receiving a selection of a direction on the directional pad causing the cursor to highlight a selectable row; and
outputting the audio corresponding to the sentence in the selected row responsive to the cursor highlighting the selectable row.

8. The computer-implemented method of claim 1, further comprising:
displaying a second user interface for displaying a list of emails, the second user interface comprising a plurality of selectable rows, each of the plurality of rows in the second user interface displaying an indication of an email from the list;
receiving a selection of one of the plurality of selectable rows from the second user interface;
displaying a third user interface for displaying a summary of an email associated with the selected row, the third user interface comprising a plurality of selectable rows, each of the plurality of selectable rows displaying an attribute from a group of attributes comprising a subject attribute, a email preview attribute, a timestamp attribute, and a recipient attribute; and
displaying the first user interface responsive to selection of the email preview attribute.

9. The computer-implemented method of claim 8, further comprising:
outputting audio corresponding to one of the plurality of selectable rows responsive to receiving user input via the steering wheel input controls positioning a cursor over the selectable row.

10. A non-transitory computer-readable storage medium storing executable code for providing an email in a vehicle, the code when executed performs the steps comprising:
receiving an email comprising text;
receiving, via input controls, input from the driver of the vehicle to output the email;
displaying a first user interface comprising a plurality of selectable rows, each row configured to display up to a threshold number of characters;
for each sentence of a plurality of sentences in the text of the email, displaying characters of the sentence in one of the plurality of selectable rows up to the threshold number of characters;
receiving, via the input controls, input from the driver selecting one of the plurality of selectable rows; and
outputting audio corresponding to the sentence in the selected row responsive to receiving the selection.

11. The non-transitory computer-readable storage medium of claim 10, wherein the code when executed further performs the steps comprising:
converting the email from a first output format to a second output format suitable for output in the vehicle.

12. The non-transitory computer-readable storage medium of claim 11, wherein converting the email comprises:
adding one or more markers to the text of the email, the markers identifying one or more clauses or sentences in the text;
creating a list of text segments based on the markers; and
creating a playlist of audio segments based on the list of text segments, each audio segment in the playlist corresponding to a text segment from the list of text segments.

13. The non-transitory computer-readable storage medium of claim 12, wherein displaying, characters of the sentence in one of the plurality of selectable rows comprises:
for each text segment in the list of text segments, displaying characters of the text segment in a selectable row up to the threshold number of characters; and
wherein the text segments are displayed in the plurality of selectable rows according to an ordering of the text segments in the list of text segments.

14. The non-transitory computer-readable storage medium of claim 12, wherein adding one or more markers to the text comprises:
identifying a length of the text based on a number of characters included in the text;
adding a marker to the text at a position corresponding to a midpoint of the text responsive to the length exceeding a threshold; and
attempting to adjust the position of the marker to either a punctuation indicative of an end of a sentence or clause in the text or to a conjunction in the text.

15. The non-transitory computer-readable storage medium of claim 10, the code when executed further performs the steps comprising:
displaying a second user interface for displaying a list of emails, the second user interface comprising a plurality of selectable rows, each of the plurality of rows in the second user interface displaying an indication of an email from the list;
receiving a selection of one of the plurality of selectable rows from the second user interface;
displaying a third user interface for displaying a summary of an email associated with the selected row, the third user interface comprising a plurality of selectable rows, each of the plurality of selectable rows displaying an attribute from a group of attributes comprising a subject attribute, a email preview attribute, a timestamp attribute, and a recipient attribute; and
displaying the first user interface responsive to selection of the email preview attribute.

16. A vehicle system for providing an email in a vehicle, the system comprising:
a computer processor; and
a computer-readable storage medium storing executable code, the code when executed by the computer processor performs the steps comprising:
receiving an email comprising text;
receiving, via input controls, input from the driver of the vehicle to output the email;
displaying a first user interface comprising a plurality of selectable rows, each row configured to display up to a threshold number of characters;
for each sentence of a plurality of sentences in the text of the email, displaying characters of the sentence in one of the plurality of selectable rows up to the threshold number of characters;
receiving, via the input controls, input from the driver selecting one of the plurality of selectable rows; and
outputting audio corresponding to the sentence in the selected row responsive to receiving the selection.

17. The vehicle system of claim 16, wherein the code when executed by the computer processor further performs the steps comprising:
converting the email from a first output format to a second output format suitable for output in the vehicle.

18. The vehicle system of claim 17, wherein converting the email comprises:
adding one or more markers to the text of the email, the markers identifying one or more clauses or sentences in the text;
creating a list of text segments based on the markers; and
creating a playlist of audio segments based on the list of text segments, each audio segment in the playlist corresponding to a text segment from the list of text segments.

19. The vehicle system of claim 18, wherein displaying, characters of the sentence in one of the plurality of selectable rows comprises:
for each text segment in the list of text segments, displaying characters of the text segment in a selectable row up to the threshold number of characters; and
wherein the text segments are displayed in the plurality of selectable rows according to an ordering of the text segments in the list of text segments.

20. The vehicle system of claim 16, wherein the code when executed by the computer processor further performs the steps comprising:
displaying a second user interface for displaying a list of emails, the second user interface comprising a plurality of selectable rows, each of the plurality of rows in the second user interface displaying an indication of an email from the list;
receiving a selection of one of the plurality of selectable rows from the second user interface;
displaying a third user interface for displaying a summary of an email associated with the selected row, the third user interface comprising a plurality of selectable rows, each of the plurality of selectable rows displaying an attribute from a group of attributes comprising a subject attribute, a email preview attribute, a timestamp attribute, and a recipient attribute; and
displaying the first user interface responsive to selection of the email preview attribute.
